(19) United States
(12) Patent Application Publication
(10) Pub. No.: US 2007/0094071 A1
(43) Pub. Date: Apr. 26, 2007

(54) Pushing content to browsers

(75) Inventors: Seana Seraji, Redmond, WA (US); Henry Y.T. Chen, Redmond, WA (US); Autumn L. Stroupe, Redmond, WA (US); Randy Ramig, Redmond, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/256,262

(22) Filed: Oct. 21, 2005

(51) Int. Cl. G06Q 30/00

(52) U.S. Cl. 705/14

(57) ABSTRACT

Users can interact with networked content by using browsers. Certain content (and/or links to certain content) can be pushed to a browser for convenient selection by a user of the browser.

### BACKGROUND

Users interact with web content by using browsers. Web sites can be selected by choosing links shown on a web page or by entering a URL for a particular site. Also, users may be browsing using a wide range of devices, such as from small, hand-held devices (having limited input/output capabilities) to larger desktop systems (which have less-limited input/output capabilities). This background is not intended to identify problems that must be addressed by the claimed subject matter of the invention.

### SUMMARY

This summary is provided to introduce a selection of concepts in a simplified form that are further described below in the Detailed Description Section. This summary is not intended to identify key features or essential features of the claimed subject matter, nor is it intended to be used as an aid in determining the scope of the claimed subject matter.

According to aspects of various described embodiments, implementations are provided for pushing content to a browser. A user interface for browsing is used to receive commands from a user for entering a string of characters for specifying content that the user wishes to receive. A list is also received of pushed content entries for content to be pushed to the user interface. At least one entry is selected from the list of pushed content entries in response to receiving a string of characters from a user. At least one of the selected pushed content entries is displayed on the user interface.

According to another aspect, a computer-implemented system for pushing content to a browser includes a user interface that is configured to receive commands from a user for entering a string of characters for specifying desired content. A file reader is configured to receive a list of pushed content entries for content to be pushed to the user interface. A selector is configured to select entries from the pushed content list in response to a desired content string. A display is configured to display an image representing at least one of the selected pushed content entries.

Embodiments may be implemented as a computer process, a computer system (including mobile hand-held computing devices) or as an article of manufacture such as a computer program product. The computer program product may be a computer storage medium readable by a computer system and encoding a computer program of instructions for executing a computer process. The computer program product may also be a propagated signal on a carrier readable by a computing system and encoding a computer program of instructions for executing a computer process.

### BRIEF DESCRIPTION OF THE DRAWINGS

Non-limiting and non-exhaustive embodiments are described with reference to the following figures, wherein like reference numerals refer to like parts throughout the various views unless otherwise specified.

FIG. 1 illustrates a user interface for pushing content to browsers, according to one embodiment.

FIG. 2 illustrates an operational flow 200 for pushing content to browsers, according to one embodiment.

FIG. 3 illustrates a general computer environment 300, which can be used to implement the techniques described herein.

### DETAILED DESCRIPTION

Various embodiments are described more fully below with reference to the accompanying drawings, which form a part hereof, and which show specific exemplary embodiments for practicing the invention. However, embodiments may be implemented in many different forms and should not be construed as limited to the embodiments set forth herein; rather, these embodiments are provided so that this disclosure will be thorough and complete, and will fully convey the scope of the invention to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

The logical operations of the various embodiments are implemented (1) as a sequence of computer implemented steps running on a computing system and/or (2) as interconnected machine modules within the computing system. The implementation is a matter of choice dependent on the performance requirements of the computing system implementing the embodiment. Accordingly, the logical operations making up the embodiments described herein are referred to alternatively as operations, steps or modules.

Exemplary System for Pushing Content to Browsers

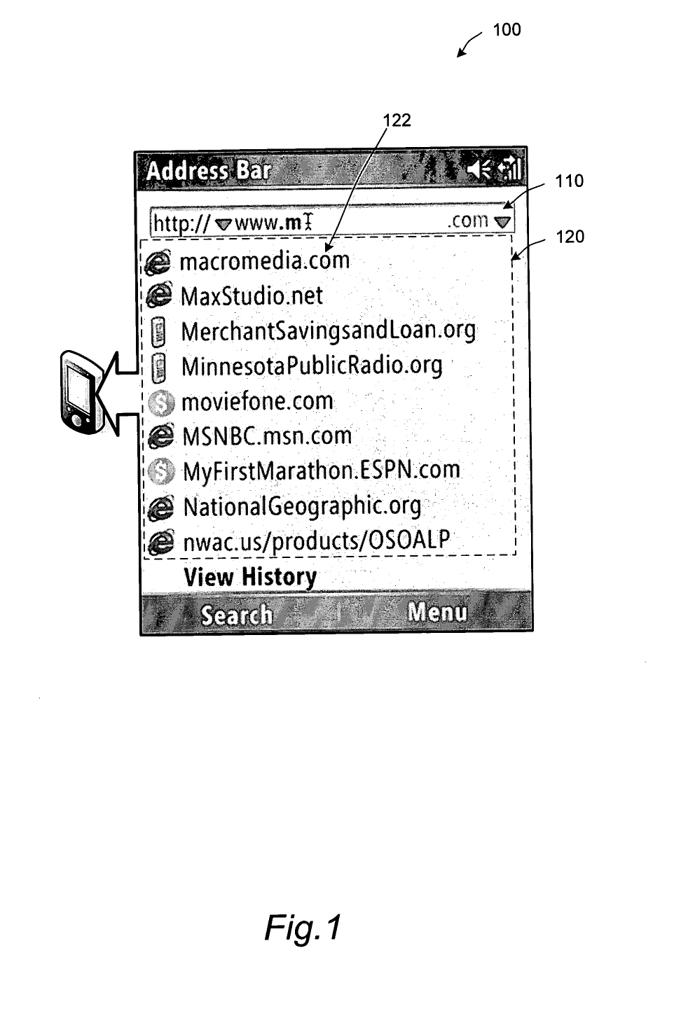

FIG. 1 illustrates a user interface for pushing content to browsers, according to one embodiment. In one embodiment, user interface 100 is implemented on a computer system, such as a mobile device, including a PDA or smartphone, that is networked to a network such as the internet. User interface 100 is used to browse, for example, web pages and content that is accessible through the internet. User interface 100 comprises URL entry bar 110 and results area 120.

Using user interface 100, a user can browse the web by selecting links optionally comprised by entries such as shown in results area 120, or by entering a URL in URL entry bar 110. A user can enter the URL by typing (or otherwise selecting) the letters sequentially. This task can be somewhat difficult when the device is a mobile device and lacks a full-fledged ergonometric user interface.

User interface 100 typically receives each letter sequentially and consults a pushed content list 122 (partially shown in results area 120) for potential matches each time a character is received. In various embodiments, results are returned when partial matches are made. Partial matches can be made when the entered characters are partially contained by (or suggest) strings (e.g., keyword indexes) that are associated with the pushed content entries of the pushed content list. Entered characters might “suggest” a keyword entry when, for example, the word is misspelled but contains a relatively high number of letters in common with a keyword entry.

The keyword idea can be more general here as well—in addition to the misspelling case, if the word entered into the address bar is a keyword (and yet not actually in the content), using keywords is also still possible. For example, if pizzashack.com paid for content to be pushed to the device, they could also potentially have purchased rights to the “restaurant” keyword. In this case, if the user entered “p-i-z” for pizza, their content would appear, but also if the user began typing in “r-e-s-t”, they would also get a match.

The push content list may be used for targeted advertising, for example, which contains links to materials “to be pushed” from one or more content providers. In response to an entered (or partially entered) word in URL entry bar 110, various entries are selected from the list and displayed in results area 120. The display can use various icons and text to describe the types of content (including services) that are being “pushed” to the user.

For example, FIG. 1 shows entries that are selected in response to the letter “M” being entered. If the letter “I” is subsequently entered, the entries “Microsoft” and “Mitsubishi” could be displayed in response to the string containing the letters of “M” and “I.” The second set of entries (selected in response to the “MI” string) is not necessarily a subset of the first set of entries (selected in response to the “M” string) because different rules for selecting strings can be applied in accordance with a wide range of selection policies.

The selection policies allow selection (and ordering) of entries, which affects the prominence in which the user is exposed to the “pushed” content. The various selection policies, for example, may include payment for prominent display. In this example, additional premiums can be required for increasing the priority in which their entry is displayed in results area 120 and/or the priority in which their entry is selected after one or more characters in the URL entry bar are retrieved. Also, extra premiums can be charged for matching sooner than later. For example, N dollars would be charged for matching to pizzashack.com after typing in “p-i-z-z-a”. Additionally, for example, four times the amount of N dollars could be charged for matching earlier, say at “p-i.”

Moreover, the entry can be positioned based on a customized level of matching based on the number of letters entered and be ranked more highly in the displayed result list. Other ordering policies can be chosen based on most frequently used, alphanumeric ranking, most recently used, most popular, and the like. For example, the most popular selections among friends/peers can be determined by sharing favorite entries with friends via the transports mentioned herein.

As also demonstrated in the Figure, a custom icon, logo and background pattern can be provided for each entry that is chosen from the list. The display can be scrolled, for example, when the selected entries are too numerous to be displayed at the same time in results area 120. The selected entries can also be displayed using a scrolling marquee. Also, a temporary (for example) full-screen advertisement can be made to appear when a keyword match is made.

The keyword to be matched does not have to be entered (or partially entered) as a fully formed URL, which can spare the user from having to laboriously type a full URL. The entered (or partially entered) word can also be a non-URL word such as “weather.” For example, a sequence of the letters “w”-“e”-“a” can cause the current weather conditions to be shown in the results area with related links for obtaining more information.

The location for the current weather conditions (or other services, such as coupons for local stores) can be selected from a user profile or other information that is associated with the user and/or device. Such location-based services include the ability for an advertiser to target location-based advertisements using location-sensitive information based on the location of the user.

Information can be pushed (or otherwise made available) to the user on the device in a number of ways. For example, a web service or open socket can be used on the web such that when the user enters text, a query is sent to the web service, which then returns the most relevant advertisements.

In cell phones and other devices capable of connecting to the internet (PDAs, for example), pushed content (including, for example, advertisements and/or links to advertisements) can be loaded from the SIM (subscriber identity module) of a GSM device. Also, the pushed content can be loaded using the payload of a Cell Broadcast message. For example, when a user moves into an area of different cell coverage, advertising information can be transmitted to the cell phone along with a standard cell broadcast message.

The pushed content can also be sent to the device during device provisioning by using, for example, an XML-like markup language. Some pushed content (such as forms and coupons) can be pre-provisioned or, for example, downloaded “in the background” when the user is not actively accessing other services.

The users can perform a variety of actions in response to the selected entries being displayed in the results area. The users can place an order for goods or services via the internet using POST, SMS or other transport system directly using the advertisement, for example, or place a phone call directly to the advertiser by selecting a button in the advertisement. Also, the advertiser can display real-time data to the user in response to the user choosing a displayed entry.

Additional features can include:
Using the user-selection to notify the owner of pushed content that their content was either selected or not selected, and to also indicate which content was chosen instead of theirs (this feedback can be useful to content owners to help them fine tune their content). The owner can fine-tune their changes, the list of content entries updated, and the updated list “pushed back” to the device.
Providing a menu to the user to dismiss certain content that appears. The browser can then analyze the user's responses and use that information to determine which content would be most appropriate to display to the user in the future (e.g., not showing them again the same content that they had dismissed).
Using the display to indicate to the user the destination of the content that appears in the content window. This feature enhances the security of the user by allowing the user to see where they are going to navigate to if they follow the link.
Providing a menu for making entering in full URLs less cumbersome. In FIG. 1, the URL entry bar 110 is divided into three components: the prefix, the content, and the suffix. The user can choose a prefix and suffix from the drop down, and this reduces they amount of input necessary. For example, if the user wants to go to http://www.microsoft.com, they would only have to type in “microsoft” (or a portion thereof), by choosing the “http://www” and “.com” portions from the drops downs.
   Exemplary Flow for Pushing Content to a Browser

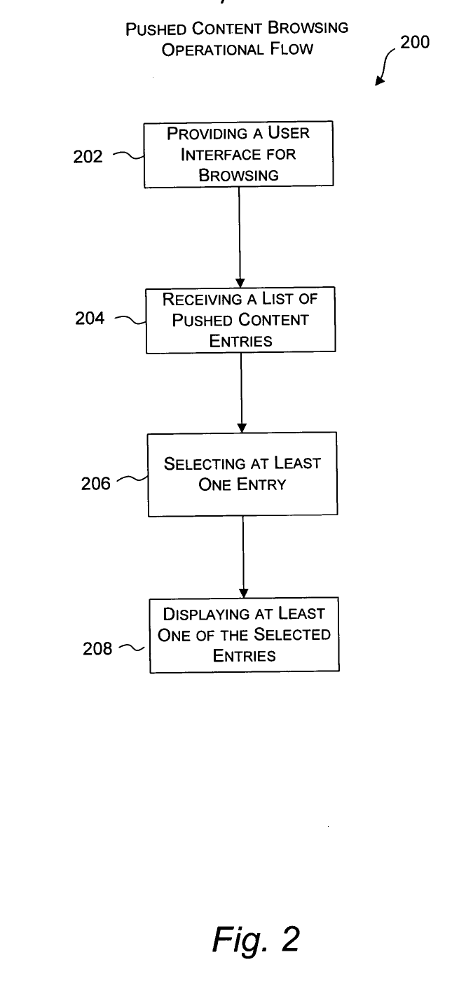

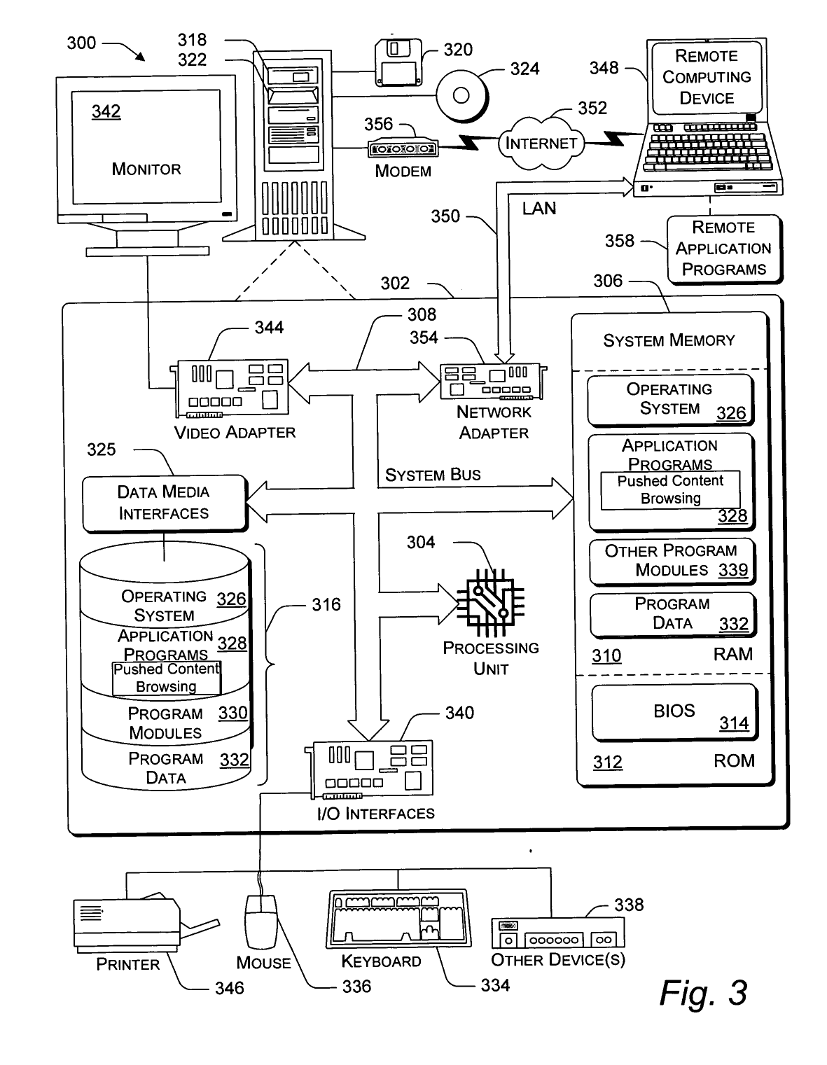

FIG. 2 illustrates an operational flow 200 for pushing content to browsers, according to one embodiment. Operational flow 200 may be performed in any suitable computing environment. For example, operational flow 200 may be executed by an application such as user application programs 328 (FIG. 3, below) to perform the searching and comparison. Therefore, the description of operational flow 200 may refer to at least one of the components of FIG. 3. However, any such reference to components of FIG. 3 is for descriptive purposes only, and it is to be understood that the implementations of FIG. 3 are a non-limiting environment for operational flow 200.

At block 202, a user interface for browsing is provided. The user interface is configured to receive commands from the user for browsing. The user interface is used to allow the user to specify kinds of or sources for content. Additionally the user interface can be used to select content from, for example, listed hyperlinks. In an embodiment, a URL bar is provided to receive commands for entering a sequence of characters to be used for selecting content. Also, a results area is provided to show entries from which content can be selected by the user.

At block 204, a list of pushed content entries is received. The list of pushed content entries contains, for example, entries of content (and/or locators for content) for which third parties would like the user to consume (or, at least, consider consuming). In an embodiment, the list of entries contains keywords (which can be, for example, subject words such as “weather” or fully-formed URLs. As described above, the entries may in themselves contain content to be consumed.

At block 206, at least one entry from the list of pushed content entries is selected in response to a string of characters input by a user. In an embodiment, entries are selected in accordance with selection policies each time a character is input by the user. The selection policies can select and prioritize the order in which the selected entries are to be displayed.

At block 208, at least one of the selected entries is displayed. In an embodiment, one or more of the selected entries are displayed using an interactive user interface metaphor such as a window, pane, bar, ribbon, and the like. Thus, the user can then select content from a list that has been pushed to the user.

Illustrative Operating Environment

FIG. 3 illustrates a general computer environment 300, which can be used to implement the techniques described herein. The computer environment 300 is only one example of a computing environment and is not intended to suggest any limitation as to the scope of use or functionality of the computer and network architectures. Neither should the computer environment 300 be interpreted as having any dependency or requirement relating to any one or combination of components illustrated in the example computer environment 300.

Computer environment 300 includes a general-purpose computing device in the form of a computer 302. The components of computer 302 can include, but are not limited to, one or more processors or processing units 304, system memory 306, and system bus 308 that couples various system components including processor 304 to system memory 306.

System bus 308 represents one or more of any of several types of bus structures, including a memory bus or memory controller, a peripheral bus, an accelerated graphics port, and a processor or local bus using any of a variety of bus architectures. By way of example, such architectures can include a Peripheral Component Interconnects (PCI) bus also known as a Mezzanine bus, a PCI Express bus (and the like), a Universal Serial Bus (USB), a Secure Digital (SD) bus, and/or an IEEE 1394, i.e., FireWire, bus.

Computer 302 may include a variety of computer readable media. Such media can be any available media that is accessible by computer 302 and includes both volatile and non-volatile media, removable and non-removable media.

System memory 306 includes computer readable media in the form of volatile memory, such as random access memory (RAM) 310; and/or non-volatile memory, such as read only memory (ROM) 312 or flash RAM. Basic input/output system (BIOS) 314, containing the basic routines that help to transfer information between elements within computer 302, such as during start-up, is stored in ROM 312 or flash RAM. RAM 310 typically contains data and/or program modules that are immediately accessible to and/or presently operated on by processing unit 304.

Computer 302 may also include other removable/non-removable, volatile/non-volatile computer storage media. By way of example, FIG. 3 illustrates hard disk drive 316 for reading from and writing to a non-removable, non-volatile magnetic media (not shown), magnetic disk drive 318 for reading from and writing to removable, non-volatile magnetic disk 320 (e.g., a “floppy disk”), and optical disk drive 322 for reading from and/or writing to a removable, non-volatile optical disk 324 such as a CD-ROM, DVD-ROM, or other optical media. Hard disk drive 316, magnetic disk drive 318, and optical disk drive 322 are each connected to system bus 308 by one or more data media interfaces 325. Alternatively, hard disk drive 316, magnetic disk drive 318, and optical disk drive 322 can be connected to the system bus 308 by one or more interfaces (not shown).

The disk drives and their associated computer-readable media provide non-volatile storage of computer readable instructions, data structures, program modules, and other data for computer 302. Although the example illustrates a hard disk 316, removable magnetic disk 320, and removable optical disk 324, it is appreciated that other types of computer readable media which can store data that is accessible by a computer, such as magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like, can also be utilized to implement the example computing system and environment.

Any number of program modules can be stored on hard disk 316, magnetic disk 320, optical disk 324, ROM 312, and/or RAM 310, including by way of example, operating system 326, one or more application programs 328 (which can include pushed content browsing as described above), other program modules 330, and program data 332. Each of such operating system 326, one or more application programs 328, other program modules 330, and program data 332 (or some combination thereof) may implement all or part of the resident components that support the distributed file system.

A user can enter commands and information into computer 302 via input devices such as keyboard 334 and a pointing device 336 (e.g., a “mouse”). Other input devices 338 (not shown specifically) may include a microphone, joystick, game pad, satellite dish, serial port, scanner, touch screen, directional pad, phone number pad, and/or the like. These and other input devices are connected to processing unit 304 via input/output interfaces 340 that are coupled to system bus 308, but may be connected by other interface and bus structures, such as a parallel port, game port, or a universal serial bus (USB).

Monitor 342 or other type of display device can also be connected to the system bus 308 via an interface, such as video adapter 344. In addition to monitor 342, other output peripheral devices can include components such as speakers (not shown) and printer 346 which can be connected to computer 302 via I/O interfaces 340.

Computer 302 can operate in a networked environment using logical connections to one or more remote computers, such as remote computing device 348. By way of example, remote computing device 348 can be a PC, portable computer, a server, a router, a network computer, a peer device or other common network node, and the like. Remote computing device 348 is illustrated as a portable computer that can include many or all of the elements and features described herein relative to computer 302. Alternatively, computer 302 can operate in a non-networked environment as well.

Logical connections between computer 302 and remote computer 348 are depicted as a local area network (LAN) 350 and a general wide area network (WAN) 352. Such networking environments are commonplace in offices, enterprise-wide computer networks, intranets, and the Internet.

When implemented in a LAN networking environment, computer 302 is connected to local area network 350 via network interface or adapter 354. When implemented in a WAN networking environment, computer 302 typically includes modem 356 or other means for establishing communications over wide area network 352. Modem 356, which can be internal or external to computer 302, can be connected to system bus 308 via I/O interfaces 340 or other appropriate mechanisms. It is to be appreciated that the illustrated network connections are examples and that other means of establishing at least one communication link between computers 302 and 348 can be employed.

In a networked environment, such as that illustrated with computing environment 300, program modules depicted relative to computer 302, or portions thereof, may be stored in a remote memory storage device. By way of example, remote application programs 358 reside on a memory device of remote computer 348. For purposes of illustration, applications or programs and other executable program components such as the operating system are illustrated herein as discrete blocks, although it is recognized that such programs and components reside at various times in different storage components of computing device 302, and are executed by at least one data processor of the computer.

Various modules and techniques may be described herein in the general context of computer-executable instructions, such as program modules, executed by one or more computers or other devices. Generally, program modules include routines, programs, objects, components, data structures, etc. for performing particular tasks or implement particular abstract data types. Typically, the functionality of the program modules may be combined or distributed as desired in various embodiments.

An implementation of these modules and techniques may be stored on or transmitted across some form of computer readable media. Computer readable media can be any available media that can be accessed by a computer. By way of example, and not limitation, computer readable media may comprise “computer storage media” and “communications media.”

“Computer storage media” includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer readable instructions, data structures, program modules, or other data in a modulated data signal, such as carrier wave or other transport mechanism. Communication media also includes any information delivery media. The term “modulated data signal” means a signal that has one or more of its characteristics set or changed in such a manner as to encode information in the signal. As a non-limiting example only, communication media includes wired media such as a wired network or direct-wired connection, and wireless media such as acoustic, RF, infrared, and other wireless media. Combinations of any of the above are also included within the scope of computer readable media.

Reference has been made throughout this specification to “one embodiment,” “an embodiment,” or “an example embodiment” meaning that a particular described feature, structure, or characteristic is included in at least one embodiment of the present invention.

Thus, usage of such phrases may refer to more than just one embodiment. Furthermore, the described features, structures, or characteristics may be combined in any suitable manner in one or more embodiments.

One skilled in the relevant art may recognize, however, that the invention may be practiced without one or more of the specific details, or with other methods, resources, materials, etc. In other instances, well known structures, resources, or operations have not been shown or described in detail merely to avoid obscuring aspects of the invention.

While example embodiments and applications of the present invention have been illustrated and described, it is to be understood that the invention is not limited to the precise configuration and resources described above. Various modifications, changes, and variations apparent to those skilled in the art may be made in the arrangement, operation, and details of the methods and systems of the present invention disclosed herein without departing from the scope of the claimed invention.

What is claimed is:

1. A computer-implemented method for pushing content to a browser, the method comprising:
providing a user interface for browsing;
receiving a list of pushed content entries for content to be pushed to the user interface;
selecting at least one entry from the list of pushed content entries in response to receiving a string of characters from a user; and
displaying on the user interface at least one of the selected pushed content entries.

2. The method of claim 1 wherein the list of pushed content entries is received via a cell broadcast message.

3. The method of claim 1 wherein the list of pushed content entries is received via a subscriber identity module.

4. The method of claim 1 wherein the list of pushed content entries is received during provisioning of a device used to provide the user interface.

5. The method of claim 1 wherein an entry from the list of pushed content entries comprises a coupon.

6. The method of claim 1 wherein an entry from the list of pushed content entries comprises a link to real time content.

7. The method of claim 1 wherein one of the at least one of the displayed pushed content entries is a full-screen advertisement.

8. The method of claim 1 wherein the displayed pushed content is displayed in accordance with an ordering policy.

9. A computer-implemented system for pushed content browsing, the system comprising:
a user interface that is configured to receive commands from a user for entering a string of characters for specifying desired content;
a file reader that is configured to receive a list of pushed content entries for content to be pushed to the user interface;
a selector that is configured to select entries from the pushed content list in response to a desired content string; and
a display that is configured to display an image representing at least one of the selected pushed content entries.

10. The system of claim 9 wherein the list of pushed content entries is generated by an internet service provider.

11. The system of claim 9 wherein the list of pushed content entries is received via the web.

12. The system of claim 9 wherein the list of pushed content entries contains entries that are localized with respect to a determined location of the user.

13. The system of claim 9 wherein an entry from the list of pushed content entries comprises a link to a coupon.

14. The system of claim 9 wherein the displayed pushed content is displayed in accordance with a monetary ordering policy.

15. A computer-implemented system for pushed content browsing, the system comprising:
means for receiving a list of pushed content entries for content to be pushed to a user interface;
means for receiving commands from a user for entering a string of characters; and
means for displaying on the user interface at least one of the selected pushed content entries in response to the received entered string of characters.

16. The system of claim 15 wherein the means for receiving commands comprises a touch screen.

17. The system of claim 15 wherein means for displaying on the user interface is further configured to change displayed data when the string of characters is concatenated with an additional character.

18. The system of claim 15 wherein one of the at least one of the displayed pushed, content entries comprises a link to a full-screen advertisement.

19. The system of claim 18 wherein the system further comprises means for receiving content that is generated in response to a user selecting one of the selected pushed content entries.

20. The system of claim 18 wherein the displayed pushed content is displayed in accordance with a most recently used ordering policy.
